(19) United States
(12) Patent Application Publication
(10) Pub. No.: US 2026/0249853 A1
(43) Pub. Date: Aug. 27, 2026

(54) CONTROL METHOD FOR VEHICLE AND DEVICE

(71) Applicant: NISSAN MOTOR CO., LTD., Yokohama-shi, Kanagawa (JP)

(72) Inventor: Kazuma SUZUKI, Kanagawa (JP)

(73) Assignee: NISSAN MOTOR CO., LTD., Yokohama-shi, Kanagawa (JP)

(21) Appl. No.: 18/994,188

(22) PCT Filed: Jul. 15, 2022
(86) PCT No.: PCT/JP2022/027798

§ 371 Date: Jan. 14, 2025

(51) Int. Cl. B60W 30/192; B60W 10/06; B60W 10/24; B60W 50/02; B60W 60/00

(52) U.S. Cl. CPC B60W 30/192; B60W 10/06; B60W 10/24; B60W 50/0225; B60W 60/00; B60W 2520/04; B60W 2710/06; B60W 2710/242

(57) ABSTRACT

A vehicle having an automatic driving function has an alternator (2), a starter motor (5), a load A group (21) including one of two automatic driving electric loads that form a redundant system, a load B group (22) including the other automatic driving electric load, a lead-acid battery (6), and a lithium-ion battery (7) for backup. During normal operation, a circuit interrupting switch (13) and a LiB relay (10) are ON, and power is supplied to the load A group (21) and the load B group (22) by power generation of the alternator (2). During execution of an idling stop control, the circuit interrupting switch (13) is turned OFF, and when restarting an engine, power is supplied to the starter motor (5) from the lead-acid battery (6). The lithium-ion battery (7) is not affected when restarting the engine.

### TECHNICAL FIELD

The present invention relates to control of a vehicle having not only a first power storage device for performing cranking but also a second power storage device for supplying power to an automatic driving electric load necessary for the automatic driving, which appropriately combines securing of power supply for the automatic driving electric load and an idling stop control.

### BACKGROUND ART

A highly reliable power supply configuration is required of a vehicle having an automatic driving function (including a so-called driving assistance function) that operates steering, braking etc. of the vehicle by a control system, as a power supply for the automatic driving electric load including an electric actuator and its control circuit to realize the operation.

Patent Document 1 discloses a configuration provided with, in addition to a main battery formed of a lead battery which supplies power to an electric load necessary for normal travel, an additional battery formed of a lithium-ion battery which supplies power to the automatic driving electric load such as ADAS actuator. This configuration is divided into a first load circuit including the main battery and general electric loads and a second load circuit including the additional battery and the automatic driving electric load, and a circuit disconnecting mechanism is provided between the first load circuit and the second load circuit. Then, change in voltage of each load circuit is monitored, and interruption (disconnection) and connection of the both load circuits are controlled.

However, this Patent Document 1 fails to disclose the idling stop control, also does not disclose how the circuit disconnecting mechanism is controlled when applying the idling stop control.

Patent Document 2 discloses a configuration provided with a main battery formed of a lithium-ion battery and a sub-battery formed of a lead battery in a vehicle having an idling stop function. Normal power supply including the cranking in a normal temperature range is performed using the main battery, whereas the sub-battery is used for power supply to a starter when an engine temperature at a time of engine start is in a low temperature range or a high temperature range.

However, in this Patent Document 2, securing of power supply for maintaining the automatic driving function is not particularly taken into consideration.

### CITATION LIST

### Patent Document

Patent Document 1: Japanese Unexamined Patent Application Publication No. JP2017-177857

Patent Document 2: Japanese Unexamined Patent Application Publication No. JP2008-167652

### SUMMARY OF THE INVENTION

A method of controlling a vehicle having a first power storage device that supplies power to at least one starting motor, a second power storage device that supplies power to an automatic driving electric load necessary for automatic driving of the vehicle, and a first disconnecting device that is provided between the automatic driving electric load and the first power storage device, according to the present invention, comprises: when predetermined conditions are satisfied at a time of vehicle stop, executing an idling stop control for stopping an engine; and controlling the first disconnecting device to be brought into an interruption state before restart of the engine at the latest when executing the idling stop control.

When the predetermined conditions are satisfied at the time of vehicle stop, the idling stop control is executed, and the engine stops. The first disconnecting device is brought into the interruption state substantially simultaneously with a start of this idling stop control or with a delay after the start of the idling stop control. While the first disconnecting device is in the interruption state, the automatic driving electric load is supplied with power by the second power storage device. After that, although the restart of the engine is performed in the event of release of a brake pedal by a driver, when performing this restart, power is supplied to the starting motor from the first power storage device. Since the first disconnecting device is in the interruption state when performing this restart, the second power storage device and the automatic driving electric load are separated (disconnected) from the first power storage device. Therefore, no power is drawn from the second power storage device to the first power storage device side.

Hence, even if the idling stop control and the restart associated with the idling stop are frequently repeated, a charge amount of the second power storage device does not considerably decreased.

### BRIEF DESCRIPTION OF THE DRAWINGS

FIG. 1 is an explanatory drawing showing a system configuration of a power supply system according to an embodiment.

FIGS. 2A to 2D are explanatory drawings showing basic operations of the power supply system according to the embodiment.

FIGS. 3A to 3F are time charts showing charge, discharge etc. of a lead-acid battery and a lithium-ion battery in an idling stop control.

FIGS. 4A to 4D are explanatory drawings showing operations in the idling stop control.

FIGS. 5A and 5B are explanatory drawings showing operations when failing to restart an engine after an idling stop.

FIGS. 6A to 6D are explanatory drawings showing operations when an ignition switch is turned OFF during the idling stop.

FIGS. 7A to 7C are explanatory drawings showing operations when a LiB relay is fixed in an interruption state.

### EMBODIMENTS FOR CARRYING OUT THE INVENTION

An embodiment of the present invention will be described in detail below with reference to the drawings.

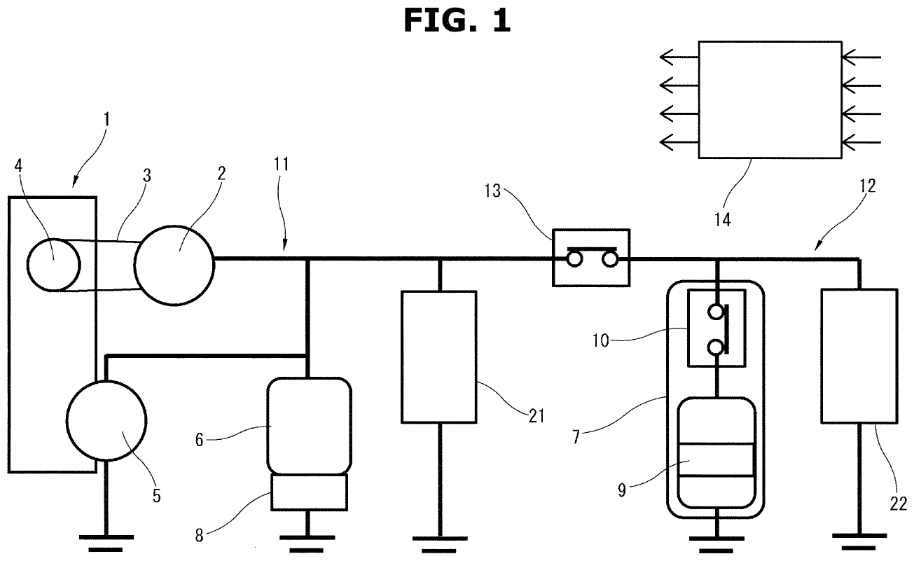

FIG. 1 is an explanatory drawing showing a system configuration of a power supply system in a vehicle having an automatic driving function according to an embodiment. The vehicle of the embodiment is a vehicle that basically travels by power of an engine 1. As the engine 1, for instance, a spark-ignition engine, i.e. a gasoline engine, can be used, but a diesel engine that performs compression self-ignition may be used. The engine 1 has a generator, e.g. an alternator 2. The alternator 2 is driven by a crank pulley 4 of the engine 1 through a belt transmission mechanism 3.

The engine 1 further has a starter motor 5 as a starting motor. The starter motor 5 is a general type starter motor having a pinion that engages with and disengages from a ring gear (not shown) of the engine 1.

Although the vehicle has a number of electric loads, in the embodiment, as schematically illustrated in FIG. 1, a number of electric loads are broadly divided into a load A group 21 and a load B group 22. The load A group 21 includes various electric loads necessary for general vehicle travel, for instance, electrical equipment such as fuel system, ignition system and control system of the engine 1, lighting, air conditioner and audio.

The load A group 21 further includes a load (corresponding to a second automatic driving electric load in claims) of one system of automatic driving electric loads necessary for the automatic driving of the vehicle, which are configured as a redundant system.

The load B group 22 includes a load (corresponding to an automatic driving electric load in claims) of the other system of the automatic driving electric loads necessary for the automatic driving of the vehicle, which are configured as the redundant system.

These two automatic driving electric loads configured as the redundant system have substantially the same functions. For instance, as an automatic driving function of level 2, a throttle valve of the engine 1 and a brake of the vehicle are controlled by a driving assistance system through electric actuators, and a steering operation of the vehicle is controlled by the driving assistance system through an electric power steering device. In order to be able to maintain the function by the other system when the one system fails, the redundant system is required of the actuators, control circuits etc. which perform the automatic driving.

For instance, the electric power steering device is configured so as to have two motor units and two motor drive control circuit units, each of which forms the redundant system. In this case, one motor unit and the corresponding motor drive control circuit unit correspond to the one automatic driving electric load included in the load A group 21, whereas the other motor unit and the corresponding motor drive control circuit unit correspond to the other automatic driving electric load included in the load B group 22.

The power supply system of the embodiment has two secondary batteries temporarily storing power generated by the alternator 2. That is, the power supply system of the embodiment has a lead-acid battery 6 corresponding to a first power storage device in claims and a lithium-ion battery 7 corresponding to a second power storage device in claims. The lead-acid battery 6 is a so-called 12V battery that is often used as an on-vehicle battery for an automobile. As the lead-acid battery 6, a battery having an appropriate capacity set with consideration given to the whole of the load A group 21 and the load B group 22 is used. The lithium-ion battery 7 is a type of backup power supply mainly used for securing power for the automatic driving electric load of the load B group 22. As the lithium-ion battery 7, for instance, a battery having a capacity that is small relative to a capacity of the lead-acid battery 6 is used. In general, an internal resistance of the lithium-ion battery is small as compared with that of the lead-acid battery, and the lithium-ion battery is superior in charge and discharge characteristics.

The lithium-ion battery 7 has a voltage equivalent to that of the lead-acid battery 6 by adjusting the member of cells.

The lead-acid battery 6 incorporates a current/voltage sensor 8 that detects a current and a voltage of the lead-acid battery 6. The current and the voltage upon charge and discharge are detected by this current/voltage sensor 8, and a charge amount (SOC) of the lead-acid battery 6 is estimated based on these current and voltage. The lithium-ion battery 7 incorporates a battery management system (BMS) 9 and a LiB relay 10 in a battery pack that accommodates therein the cells. The battery management system 9 detects a voltage and a current per cell unit, and suppresses overcharge and overdischarge of the lithium-ion battery 7, and also performs equalization of the cell voltage, and calculates a charge amount (SOC) of the lithium-ion battery 7. Further, the battery management system 9 detects a cell temperature, and monitors an overcurrent, then has a function of protecting the lithium-ion battery 7 by interrupting (cutting off) the LiB relay 10 at a time of, for instance, an abnormally high temperature or the overcurrent. The LiB relay 10 is formed of a relay having a contact point, and corresponds to a second disconnecting device in claims.

The lead-acid battery 6 is connected to, as a main circuit 11, the alternator 2, the starter motor 5 and the load A group 21. The lithium-ion battery 7 incorporating the LiB relay 10 is connected to, as a backup circuit 12, the load B group 22. The main circuit 11 and the backup circuit 12 are connected to each other through a circuit interrupting switch 13 (corresponding to a first disconnecting device in claims). The circuit interrupting switch 13 is configured by a semiconductor switch with consideration given to responsiveness. As illustrated in FIG. 1, the circuit interrupting switch 13 is disposed between the lead-acid battery 6 for supplying power to the starter motor 5 and the load B group 22 formed mainly by the automatic driving electric load.

Disconnection (interruption) of the circuit interrupting switch 13 and disconnection (interruption) of the LiB relay 10 are controlled by a controller 14 that governs a power supply control. The controller 14 further controls a voltage and a power generation amount of the alternator 2, and also controls the starter motor 5 when starting the engine 1 (initial start and restart after the idling stop). It is noted that the controller 14 may be configured by a plurality of modules or controllers.

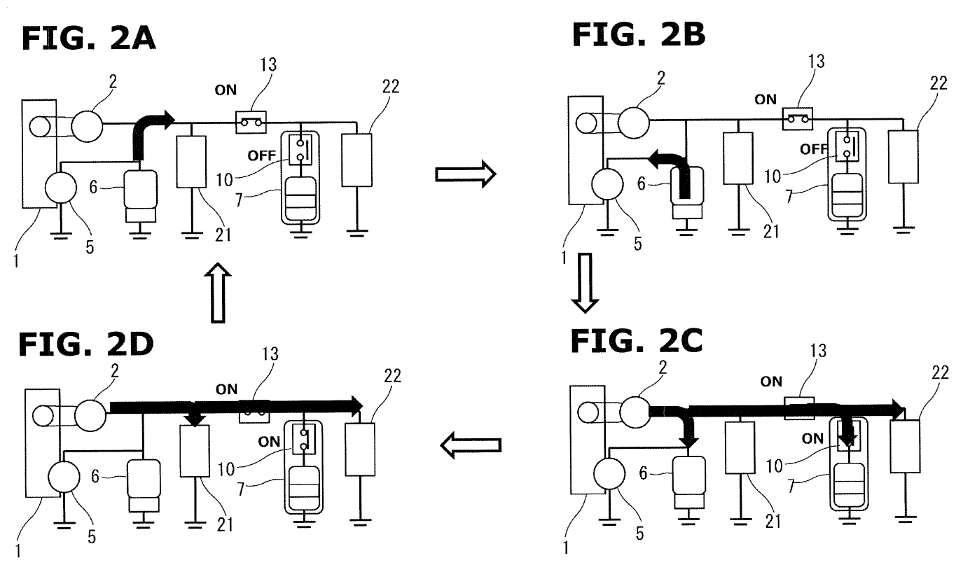

FIGS. 2A to 2D are explanatory drawings showing basic operations of the power supply system of the embodiment shown in FIG. 1. In the following explanatory drawings including FIGS. 2A to 2D, a main current flow is indicated by an arrow. FIG. 2A illustrates a state in which an ignition switch of the vehicle is OFF. In this ignition switch OFF state, the circuit interrupting switch 13 is ON (conduction state), and the LiB relay 10 is controlled to be OFF (interruption state or cut-off state). Although a number of electric loads do not require power in this ignition switch OFF state, some electric loads consume power even during standby, and a so-called standby current flows in the circuit. As indicated by the arrow in FIG. 2A, power required for both of the load A group 21 and the load B group 22 during standby is supplied by the lead-acid battery 6. Since the LiB relay 10 is in the cut-off state, the charge amount of the lithium-ion battery 7 does not decrease.

When the ignition switch is turned ON, as indicated by the arrow in FIG. 2B, power is supplied to the starter motor 5 from the lead-acid battery 6, and cranking and start (initial start) of the engine 1 are carried out. During the cranking, the LiB relay 10 is held OFF, and the lithium-ion battery 7 does not consume power.

When completing the engine start, as illustrated in FIG. 2C, the LiB relay 10 is turned ON. Therefore, as indicated by the arrows, by power generation of the alternator 2, both of the lead-acid battery 6 and the lithium-ion battery 7 are charged. Each voltage is controlled so that the charge amount of the lead-acid battery 6, which has been decreased due to its power consumption during the ignition switch OFF and during the cranking, and the charge amount of the lithium-ion battery 7, which has been slightly lowered due to natural discharge (self-discharge), are quickly recovered.

FIG. 2D illustrates a normal travel state in which the lead-acid battery 6 and the lithium-ion battery 7 are sufficiently charged. The circuit interrupting switch 13 and the LiB relay 10 are each in an ON state. In this state, the load A group 21 and the load B group 22 are basically supplied with power from the alternator 2. If the charge amount of the lithium-ion battery 7 is sufficiently charged, the use of the automatic driving function is permitted. Further, if the charge amount of the lead-acid battery 6 is sufficiently charged, an idling stop control for stopping operation of the engine 1 at a time of vehicle stop at an intersection etc. is permitted.

When the vehicle stops and the ignition switch is turned OFF from the control state of FIG. 2D, the LiB relay 10 is turned OFF, and the state is returned to FIG. 2A again.

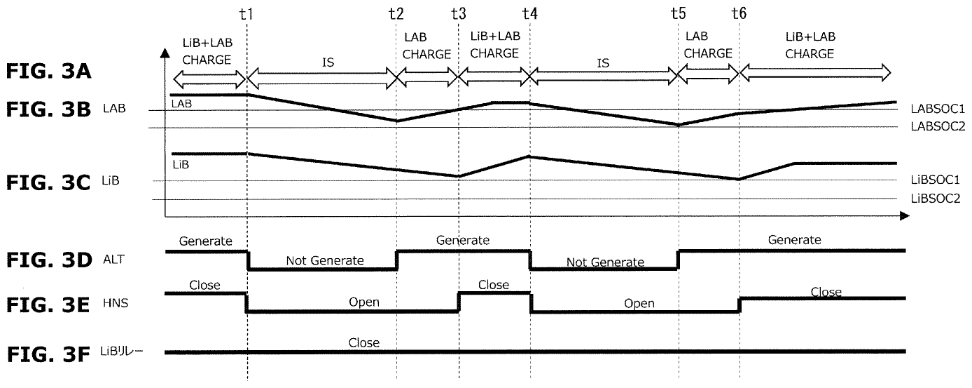

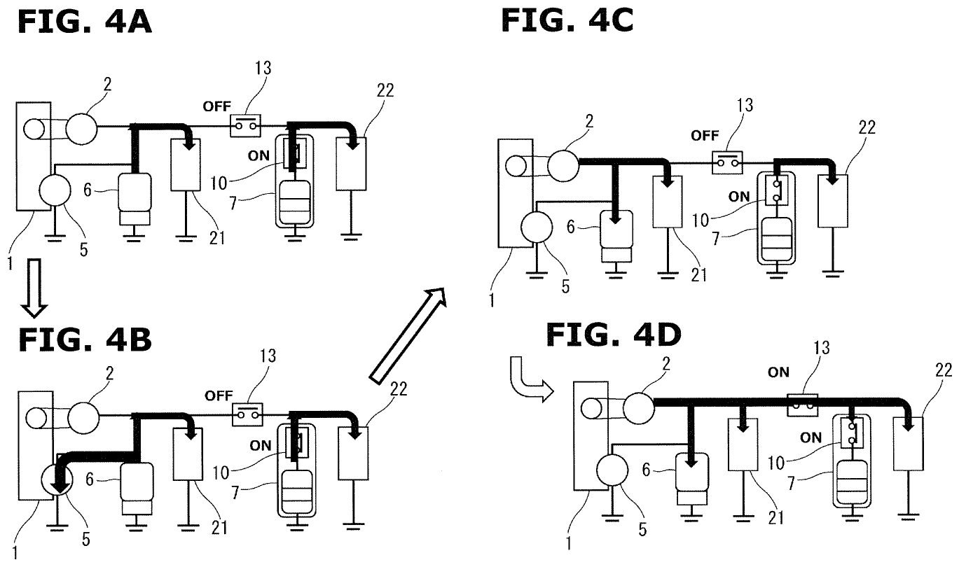

Next, the power supply control when performing the idling stop control, which is an essential part of the present invention, will be described with reference to time charts of FIGS. 3A to 3F and operation explanatory drawings of FIGS. 4A to 4D.

The idling stop control is an effective means in terms of reduction in fuel consumption of the vehicle. The idling stop control is executed when several idling stop conditions, such as a vehicle speed being substantially zero, after warming-up (i.e. warming-up being completed), an accelerator pedal OFF, a brake pedal ON, the charge amount of the lead-acid battery 6 and the charge amount of the lithium-ion battery 7 being predetermined levels (after-mentioned LABSOC2, LiBSOC1) or more, etc., are simultaneously satisfied (so-called AND conditions), and the engine 1 is automatically stopped. After that, when any one of several restart conditions, such as a brake pedal OFF, a start request from the air conditioner, etc., is satisfied (so-called OR condition), automatic restart is executed.

FIGS. 4A to 4D are explanatory drawings showing operations when performing the idling stop control. When the idling stop conditions are satisfied and the idling stop control is started from the normal control state of FIG. 2D, as illustrated in FIG. 4A, the circuit interrupting switch 13 is turned OFF, whereas the LiB relay 10 remains in the ON state. Because the engine 1 stops and the power generation of the alternator 2 stops while the idling stop control is executed, the load A group 21 is supplied with power from the lead-acid battery 6, and the load B group 22 is supplied with power from the lithium-ion battery 7. With this, the two automatic driving electric loads, which are included in the load A group 21 and the load B group 22 respectively and form the redundant system, are surely supplied with power.

Here, as one of the idling stop conditions, it is preferable to include a condition that the LiB relay 10 is actually in the ON state in the idling stop conditions. That is, it is desirable to prevent the idling stop control from being started in a state in which power supply to the load B group 22 from the lithium-ion battery 7 is not possible.

Next, when the restart condition is satisfied and the restart is performed, as illustrated in FIG. 4B, power is supplied to the starter motor 5 from the lead-acid battery 6, and the cranking for the restart is executed. At this time, the circuit interrupting switch 13 is held OFF, and the LiB relay 10 is held ON. Therefore, while power supply from the lithium-ion battery 7 to the automatic driving electric load of the load B group 22 is continued, the lithium-ion battery 7 is separated (disconnected) from the starter motor 5 and the lead-acid battery 6, then no power is drawn from the lithium-ion battery 7 to the main circuit 11 side. Since the internal resistance of the lithium-ion battery 7 is small as compared with that of the lead-acid battery 6, if both of the lead-acid battery 6 and the lithium-ion battery 7 are connected to the starter motor 5, power on the lithium-ion battery 7 side is preferentially consumed. Since the circuit interrupting switch 13 is OFF, the lithium-ion battery 7 is not affected when performing the restart.

Here, in the above embodiment, in preparation for the restart, the circuit interrupting switch 13 is controlled to be OFF substantially simultaneously with the start of the idling stop control. Therefore, a delay time for turning the circuit interrupting switch 13 OFF when a restart request arises does not occur, and the restart can be executed quickly. In addition, there is no concern of drawing of power from the lithium-ion battery 7 to the load A group 21 during the idling stop control.

FIG. 4C indicates a control state immediately after the restart. After the restart, first, charge of the lead-acid battery 6 is preferentially carried out. Therefore, a state in which the circuit interrupting switch 13 is OFF continues for a predetermined time period after the restart. By power generation of the alternator 2, the lead-acid battery 6 is charged. For this time period, the load B group 22 is supplied with power from the lithium-ion battery 7. These are carried out in consideration of the fact that power of the lead-acid battery 6 has been consumed due to the cranking when performing the restart and that the internal resistance of the lead-acid battery 6 is greater than that of the lithium-ion battery 7.

After that, as illustrated in FIG. 4D, the circuit interrupting switch 13 is controlled to be ON, and both of the lead-acid battery 6 and the lithium-ion battery 7 are charged.

FIGS. 3A to 3F are time charts showing the power supply control when performing the idling stop control. In this example, the idling stop control is executed twice. In an uppermost FIG. 3A, a period denoted by “IS” is a period of the idling stop control (corresponding to FIG. 4A), a period denoted by “LAB CHARGE” is a preferential charge period of the lead-acid battery 6 (corresponding to FIG. 4C), and a period denoted by “LiB+LAB CHARGE” is a charge period of the both lithium-ion battery 7 and lead-acid battery 6 (corresponding to FIG. 4D). As described above, after the idling stop control is ended, the preferential charge period of the lead-acid battery 6 comes, and subsequently, the control is shifted to the charge of the both lithium-ion battery 7 and lead-acid battery 6.

FIG. 3B indicates change in the charge amount (SOC) of the lead-acid battery 6 (in the drawing, this is abbreviated as “LAB”). LABSOC 1 is a target SOC of the lead-acid battery 6 for ending the preferential charge of the lead-acid battery 6 after the restart. LABSOC 2 is an idling stop prohibition SOC of the lead-acid battery 6 which is one of the idling stop conditions. The LABSOC 2 is set to a value that is lower than the LABSOC 1. When the charge amount (SOC) of the lead-acid battery 6 falls below the LABSOC 2, the idling stop control is prohibited, and after that, a state in which the idling stop control is prohibited continues as a so-called hysteresis until the charge amount (SOC) of the lead-acid battery 6 is returned (recovered) to the LABSOC 1. The charge amount of the lead-acid battery 6 decreases due to the power consumption of the load A group 21 during the idling stop control and due to the cranking when performing the restart, and subsequently increases in the charge period. In the example shown in the drawing, the preferential charge period of the lead-acid battery 6 after the first idling stop control is ended by the fact that the charge amount of the lead-acid battery 6 reaches the LABSOC 1 at time t3. That is, the predetermined time period for which the preferential charge of the lead-acid battery 6 is performed is considered to elapse by the fact that the charge amount of the lead-acid battery 6 reaches the charge target LABSOC 1. Here, the first idling stop control is ended by, for instance, the brake pedal OFF by a driver at time t2. A second idling stop control is ended by the fact that the charge amount of the lead-acid battery 6 is lowered to the LABSOC 2 at time t5.

FIG. 3C indicates change in the charge amount (SOC) of the lithium-ion battery 7 (in the drawing, this is abbreviated as “LiB”). LiBSOC 1 is an idling stop prohibition SOC for prohibiting the idling stop control when the charge amount (SOC) of the lithium-ion battery 7 is the LiBSOC 1 or less.

This LiBSOC 1 is also a lower limit SOC indicating that the lithium-ion battery 7 should be charged, and when the charge amount of the lithium-ion battery 7 is lowered to the LiBSOC 1 while the preferential charge of the lead-acid battery 6 is performed after the idling stop control, the control is shifted to the charge of the both lithium-ion battery 7 and lead-acid battery 6. LiBSOC 2 is an automatic driving warning SOC that is a lower limit capable of outputting power necessary for the automatic driving function to the automatic driving electric load of the load B group 22. When the charge amount of the lithium-ion battery 7 falls below this LiBSOC 2 during execution of the automatic driving, an alert (voice, screen display, etc.) that alerts the driver to change the automatic driving to a manual driving is issued. The LiBSOC 1 is set to a value that is higher than the LiBSOC 2 so that an appropriate margin before the issuance of the alert is given. The charge amount of the lithium-ion battery 7 decreases due to the power consumption of the load B group 22 during the idling stop control and in the subsequent preferential charge period of the lead-acid battery 6, and increases in the charge period of the both lithium-ion battery 7 and lead-acid battery 6. In the example shown in the drawing, the preferential charge period of the lead-acid battery 6 after the second idling stop control is ended by the fact that the charge amount of the lithium-ion battery 7 is lowered to the LiBSOC 1 at time t6. That is, a predetermined time period for which the preferential charge of the lead-acid battery 6 is performed is considered to elapse by the fact that the charge amount of the lithium-ion battery 7 is lowered to the LiBSOC 1.

It is noted that the predetermined time period for which the preferential charge of the lead-acid battery 6 is performed may be determined by its duration time. In this case, the preferential charge of the lead-acid battery 6 is ended when a certain time has elapsed, then the control is shifted to the charge of the both lithium-ion battery 7 and lead-acid battery 6.

FIG. 3D indicates whether the alternator 2 is in a power generating state (Generate) or a non-power generating state (Not Generate) (in the drawing, this is abbreviated as “ALT”). The power generation stops during the idling stop control.

FIG. 3E indicates an open/closed state of the circuit interrupting switch 13 (in the drawing, this is abbreviated as “HNS”). The circuit interrupting switch 13 is open (OFF) during the idling stop control and in the preferential charge period of the lead-acid battery 6, and is closed (ON) in the charge period of the both lithium-ion battery 7 and lead-acid battery 6. FIG. 3F indicates an open/close state of the LiB relay 10. The LiB relay 10 is held in a closed state (ON) in a period of the time chart of the drawing.

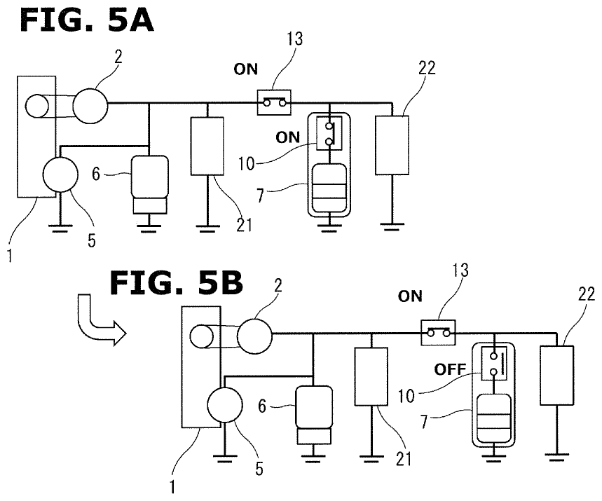

FIGS. 5A and 5B are explanatory drawings showing operations when failing to restart the engine 1 for some reason after the idling stop control. The cranking for the restart is performed, as shown in FIG. 4B described above, with the circuit interrupting switch 13 being OFF and the LiB relay 10 being ON. When failing to restart the engine 1 from this state, as illustrated in FIG. 5A, first, the circuit interrupting switch 13 is turned ON, then power supply to the load B group 22 is secured, and after that, as illustrated in FIG. 5B, the LiB relay 10 is turned OFF, then the lithium-ion battery 7 is separated (disconnected) from the circuit. The LiB relay 10 is prohibited from being OFF until the circuit interrupting switch 13 is turned ON. After the LiB relay 10 is turned OFF, start of the engine 1 (the cranking) is permitted.

The start of the engine 1 after failing to restart the engine 1 is performed by the driver operating the ignition switch (e.g. a push switch) again.

In this manner, by turning the LiB relay 10 OFF after controlling the circuit interrupting switch 13 to be ON, power supply to the automatic driving electric load of the load B group 22 is not interrupted.

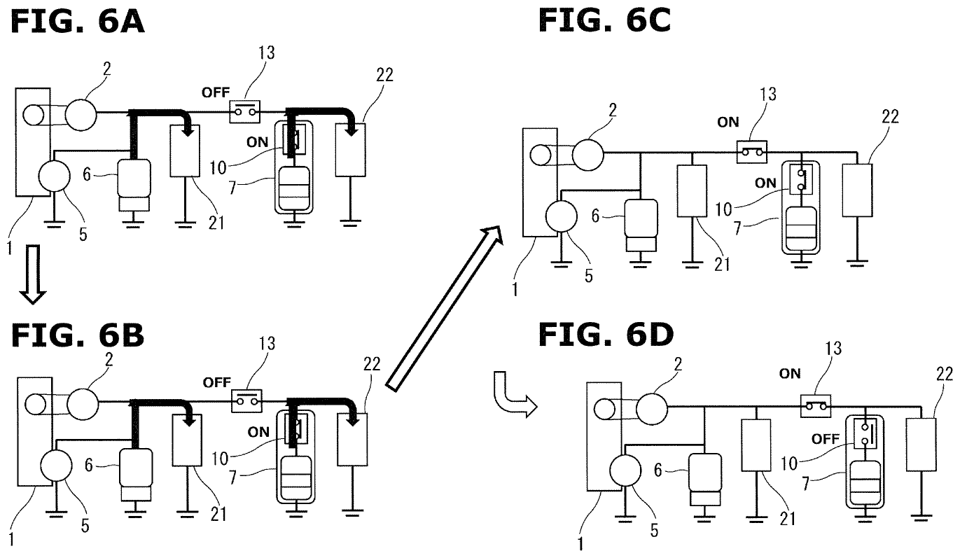

FIGS. 6A to 6D are explanatory drawings showing operations when the ignition switch is turned OFF during the idling stop control. For instance, when the vehicle arrives at a destination and temporarily stops, the idling stop control may be started, and the driver may turn the ignition switch OFF as it is. FIG. 6A shows, as same as FIG. 4A, a state in which the idling stop control is in progress and the circuit interrupting switch 13 is OFF and the LiB relay 10 is ON. When the ignition switch is turned OFF in this state, as illustrated in FIG. 6B, the LiB relay 10 remains fixed to ON with the circuit interrupting switch 13 being OFF.

In this state, discharge of the lithium-ion battery 7 occurs, for instance, during the vehicle stop.

Therefore, as illustrated in FIG. 6C, first, the circuit interrupting switch 13 is turned ON, then power supply to the load B group 22 is secured, and after that, as illustrated in FIG. 6D, the LiB relay 10 is turned OFF, then the lithium-ion battery 7 is separated (disconnected) from the circuit. The LiB relay 10 is prohibited from being OFF until the circuit interrupting switch 13 is turned ON.

This state of FIG. 6D is the same as the normal ignition switch OFF state shown in FIG. 2A.

Therefore, after this state, standby power for the load A group 21 and the load B group 22 is supplied by the lead-acid battery 6. Further, when the driver turns the ignition switch ON, as described above, power is supplied to the starter motor 5 from the lead-acid battery 6 (see FIG. 2B). Here, as illustrated in FIG. 6D, the engine start using the starter motor 5 is prohibited until the LiB relay 10 is turned OFF. Therefore, discharge of the lithium-ion battery 7 is surely avoided.

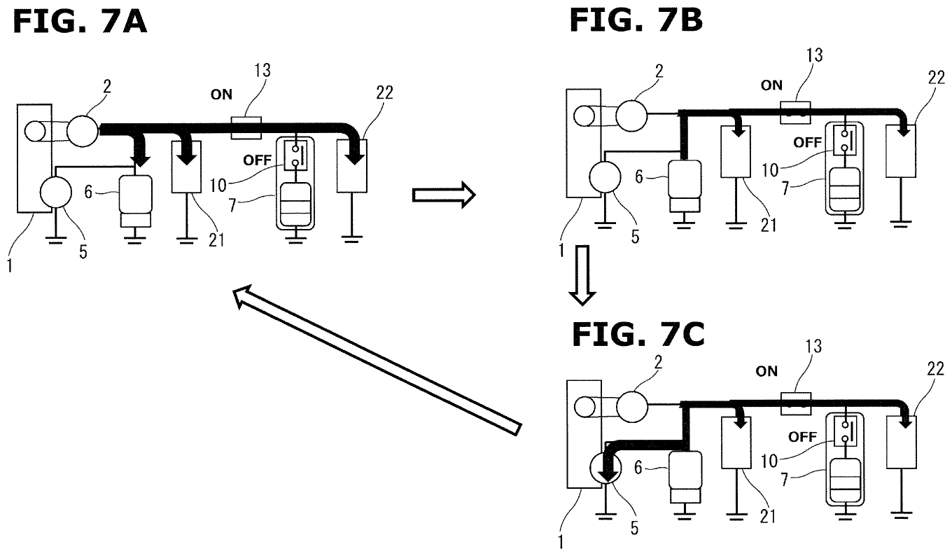

FIGS. 7A to 7C are explanatory drawings showing operations when the LiB relay 10 is fixed in an open state, i.e. an interruption state (a cut-off state). FIG. 7A illustrates a state in which the LiB relay 10 is fixed in the open state during the normal travel. In this state, power is supplied to the load A group 21 and the load B group 22 by power generation of the alternator 2, and the lead-acid battery 6 is charged depending on situation. Since the LiB relay 10 is fixed in the open state, the lithium-ion battery 7 is separated (disconnected) from the circuit. When such open fixation of the LiB relay 10 is detected, the controller 14 prohibits the automatic driving. On the other hand, even when the LiB relay 10 is fixed in the open state, the idling stop control can be executed as normal. Therefore, when the predetermined idling stop conditions are satisfied, the idling stop control is started, and the engine 1 stops. FIG. 7B illustrates a state in which this idling stop control is in progress. FIG. 7C illustrates a state when performing the restart after the idling stop control is ended. As illustrated in FIG. 7B, unlike the normal idling stop control (FIG. 4A) capable of operating the LiB relay 10, the idling stop control is started with the circuit interrupting switch 13 being controlled to be held in the ON state.

Therefore, power is supplied to the load B group 22 from the lead-acid battery 6 during the idling stop control. As illustrated in FIG. 7C, the restart is also performed with the circuit interrupting switch 13 remaining in the ON state, and power supply to the load B group 22 from the lead-acid battery 6 is continued. After the restart, the control is returned to the state of FIG. 7A as it is.

Although the invention has been described above by reference to the embodiment of the invention, the invention is not limited to the embodiment described above, and various modifications can be made. For instance, in the above embodiment, the circuit interrupting switch 13 is controlled to be OFF substantially simultaneously with the start of the idling stop control (see FIG. 4A). However, the circuit interrupting switch 13 may be controlled to be OFF with a delay after the start of the idling stop control, and the circuit interrupting switch 13 is controlled to be OFF before the restart at the latest. Further, in the above embodiment, the lead-acid battery 6 is used as the first power storage device, and the lithium-ion battery 7 is used as the second power storage device. However, as the power storage device, any type of devices such as proper secondary battery and capacitor could be used.

Further, the above embodiment is described with the alternator 2 being the mere generator and the starter motor 5 being the only starting motor.

However, the cranking at the time of the engine start could be performed using a motor/generator having the function as a generator. Alternatively, the motor/generator having the function as the generator and the starter motor are provided, the initial start could be executed by the starter motor, and the restart after the idling stop control could be executed by the motor/generator. In this case, both of the motor/generator also serving as the generator and the starter motor are regarded as the starting motors.

In addition, in the above embodiment, the automatic driving electric load is divided into the two electric loads as the redundant system. However, the present invention is not limited to this redundant system, but can be applied to other redundant system.

1.-10. (canceled)

11. A method of controlling a vehicle having a first power storage device that supplies power to at least one starting motor, a second power storage device that supplies power to an automatic driving electric load necessary for automatic driving of the vehicle, a first disconnecting device that is provided between the automatic driving electric load and the first power storage device, and a second disconnecting device provided between the automatic driving electric load and the second power storage device, the method comprising:
when predetermined conditions are satisfied at a time of vehicle stop, executing an idling stop control for stopping an engine;
controlling the first disconnecting device to be brought into an interruption state before restart of the engine at the latest when executing the idling stop control; and
when an ignition switch of the vehicle is turned OFF during execution of the idling stop control, controlling the first disconnecting device to be brought into a conduction state, and subsequently, controlling the second disconnecting device to be brought into an interruption state.

12. The method of controlling the vehicle as claimed in claim 11, further comprising:
prohibiting start of the engine by the starting motor until the second disconnecting device is brought into the interruption state.

13. The method of controlling the vehicle as claimed in claim 11, further comprising:
when ending the idling stop control and restarting the engine, driving the starting motor by power of the first power storage device with the first disconnecting device being held in the interruption state.

14. The method of controlling the vehicle as claimed in claim 13, further comprising:
when failing to restart the engine, controlling the first disconnecting device to be brought into a conduction state, subsequently, controlling the second disconnecting device to be brought into an interruption state, and driving the starting motor by power of the first power storage device.

15. The method of controlling the vehicle as claimed in claim 11, further comprising:
when the second disconnecting device is fixed in an interruption state and also the predetermined conditions are satisfied at the time of the vehicle stop, executing the idling stop control with the first disconnecting device being held in a conduction state.

16. The method of controlling the vehicle as claimed in claim 11, further comprising:
when the second disconnecting device is fixed in an interruption state, prohibiting the automatic driving of the vehicle.

17. The method of controlling the vehicle as claimed in claim 11, further comprising:
as one of the predetermined conditions, including a condition that the second disconnecting device is in a conduction state.

18. The method of controlling the vehicle as claimed in claim 11, wherein
the vehicle further has, in addition to the automatic driving electric load, a second automatic driving electric load for the automatic driving of the vehicle which forms a redundant system, and
the method further comprising:
when the first disconnecting device is in the interruption state, supplying power to the second automatic driving electric load from the first power storage device.

19. A control device of a vehicle comprising:
a first power storage device configured to supply power to at least one starting motor;
a second power storage device configured to supply power to an automatic driving electric load necessary for automatic driving of the vehicle;
a first disconnecting device provided between the automatic driving electric load and the first power storage device;
a second disconnecting device provided between the automatic driving electric load and the second power storage device; and
a controller configured to, when predetermined conditions are satisfied at a time of vehicle stop, execute an idling stop control for stopping an engine, and control the first disconnecting device to be brought into an interruption state before restart of the engine at the latest, and further configured to, when an ignition switch of the vehicle is turned OFF during execution of the idling stop control, control the first disconnecting device to be brought into a conduction state, and subsequently, control the second disconnecting device to be brought into an interruption state.
